(19) United States
(12) Patent Application Publication
(10) Pub. No.: US 2008/0292857 A1
(43) Pub. Date: Nov. 27, 2008

(54) HEAT DISSIPATION SUBSTRATE AND HEAT DISSIPATION MATERIAL THEREOF

(75) Inventors: David Shau Chew Wang, Taipei City (TW); Kuo Hsun Chen, Toufen Town (TW); En Tien Yang, Taipei City (TW)

Correspondence Address: CONNOLLY BOVE LODGE & HUTZ LLP, 1875 EYE STREET, N.W., SUITE 1100, WASHINGTON, DC, 20006, US

(73) Assignee: POLYTRONICS TECHNOLOGY CORPORATION, Hsinchu (TW)

(21) Appl. No.: 12/052,839

(22) Filed: Mar. 21, 2008

(30) Foreign Application Priority Data
May 23, 2007 (TW) 096118269

(51) Int. Cl. B32B 15/08; B32B 27/20; C08L 27/18; C08K 3/20; C08K 3/38; C08K 3/22; C08K 3/28; B32B 15/20

(52) U.S. Cl. 428/220; 428/339; 524/546; 524/428; 524/430; 524/432; 524/435; 524/404

(57) ABSTRACT

A heat dissipation material comprises (1) fluorine-containing crystalline polymer having a melting point higher than 150° C., with a weight percentage of around 15-40%; (2) heat conductive fillers dispersed in the fluorine-containing crystalline polymer with a weight percentage of around 60-85%; and (3) coupling agent of 0.5-3% of the heat conductive fillers by weight and having a chemical formula of:

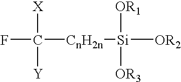

where R1, R2 and R3 are alkyl group CₐH₂ₐ₊₁, a≧1; X and Y are selected from hydrogen, fluorine, chorine, and alkyl group; and n is a positive integer.

### BACKGROUND OF THE INVENTION

(A) Field of the Invention

The present invention relates to a heat dissipation substrate and the heat dissipation material thereof, and more specifically, to a heat dissipation substrate and the heat dissipation material thereof applied for electronic devices.

(B) Description of the Related Art

Other than real energy consumption for device operation, the majority of the electrical energy consumed by electronic devices during operation is transferred into heat and dissipated. The heat generated by the electronic device rapidly increases the inner temperature of the electronic device. If the heat cannot be dissipated effectively, the electronic device will be of higher temperature or lose efficacy due to overheating. Therefore, the reliability of these electronic devices will be decreased.

Surface mounted technology (SMT) allows electronic devices disposed in the printed circuit board (PCB) with higher density, resulting in reduced size of effective heat dissipation area. The resulting increase in device temperature will seriously impact the reliability of the device. The high heat of the white light emitting diode (LED), which attracts widespread attention around the world, will negatively impact the intensity of the light and the durability of the LED device. Therefore, heat dissipation design becomes very important.

In addition to monitor backlights and common lighting apparatuses, it is common to use multiple LED devices on circuit boards. In addition to serving as an LED module carrier, the circuit board also provides heat dissipation functionality.

A known printed circuit board consisting of fiber glass FR4 with copper foil thereon has a heat dissipation coefficient around 0.3 W/m-K, which does not meet current demand. Moreover, the heat dissipation substrate using FR4 is difficult to bend, making it not suitable for folded-product applications.

### SUMMARY OF THE INVENTION

The present invention provides a heat dissipation substrate having superior heat dissipation capability, insulation behavior withstanding high voltages, and bendability. Thus, the substrate can serve PCB for heat dissipation of electronic devices, e.g., high power LED devices, disposed thereon.

The present invention discloses a heat dissipation material and a heat dissipation substrate. The heat dissipation substrate comprises a first metal foil, a second metal foil and a heat dissipation material layer. The heat dissipation material layer is laminated between the first and second material layers by physical contact. The heat dissipation material layer has a heat dissipation coefficient greater than 1.0 W/m-K and a thickness less than 0.5 mm. The material of the heat dissipation material layer comprises (1) fluorine-containing crystalline polymer having a melting point higher than 150° C. and a weight percentage of around 15-40%; (2) heat conductive filler dispersed in the fluorine-containing crystalline polymer with a weight percentage of around 60-85%; and (3) coupling agent being 0.5-3% of the heat conductive filler by weight and having a chemical formula:

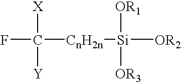

where R1, R2 and R3 are alkyl group CₐH₂ₐ₊₁, a≧1;

X and Y are selected from hydrogen, fluorine, chorine, and alkyl (CₐH₂ₐ₊₁) group; and n is a positive integer.

Preferably, the fluorine-containing crystalline polymer may be polyethylenetetrafluoroethylene (PETE) or Poly Vinylidene Fluoride (PVDF). The melting point of PETFE is greater than 220° C. and the melting point of PVDF is greater than 150° C. Both of them have higher melting points and can be flame retardant. In other words, they can withstand high temperature and do not catch fire easily, and thus are valuable in consideration of safety. The heat conductive fillers can use ceramic heat conductive materials such as oxide or nitride.

In addition to superior heat conduction and insulation, if the thicknesses of the first metal foil and the second metal foil are less than 0.1 mm and 0.2 mm, and the thickness of the heat dissipation layer is less than 0.5 mm (preferably 0.3 mm), the substrate having a width of 1 cm can pass a bending test in which the test substrate is bent to a circle of a diameter of 10 mm without breaking or cracking on the surface thereof. Therefore, it can be applied to folded products.

### BRIEF DESCRIPTION OF THE DRAWINGS

FIG. 1 illustrates a heat dissipation substrate in accordance with an embodiment of the present invention.

### DETAILED DESCRIPTION OF THE INVENTION

The heat dissipation material of the present invention comprises fluorine-containing crystalline polymer, heat conductive fillers and coupling agent. The ingredient, percentage and manufacturing method are disclosed as follows.

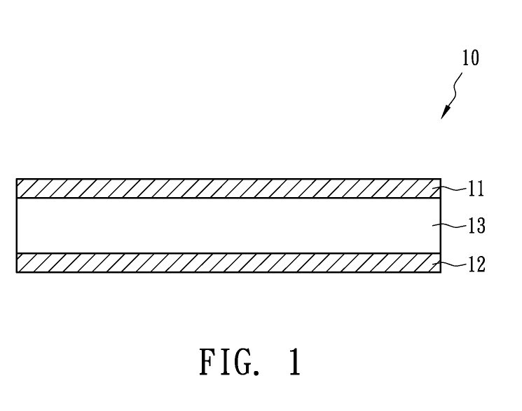

The heat dissipation material can be associated with metal foils to form a heat dissipation substrate, and the manufacturing method is exemplified as follows. (1) Fluorine-containing crystalline polymer of 24 shares and heat conductive fillers of 76 shares and coupling agent are put in a ball grinding jar, and they are mixed in a condition of 100 rpm for 12 hours. In other words, the fluorine-containing crystalline polymer and the heat conductive fillers have a weight ratio of 24:76. (2) The pre-mixed materials are put into a Kneader blender having oil temperature of 240° C. and blended at 45 rpm. After the materials are melted to be uniform, the blending is completed at around 270° C. (3) The melted material in the Kneader blender is put into a cutting machine and cut into small pieces at 300° C. (4) The small pieces are put in a twin-screw extruder to form a laminate at 280° C., and then the laminate is adhered to metal foils such as copper foils by a presser, so as to form a heat dissipation substrate 10 as shown in FIG. 1. The thickness of the substrate 10 including the metal foil is around 0.27 mm.

The heat dissipation substrate 10 comprises a first metal foil 11, a second metal foil 12 and a heat dissipation material layer 13 laminated between the first and the second metal foils 11 and 12. The heat dissipation material layer 13 comprises the above-mentioned heat dissipation material. The first and second metal foils 11 and 12 are in physical contact with the heat dissipation material layer 13, and the metal foils 11 and 12 in contact with the heat dissipation material layer 13 may comprise nodules that increase the bonding strength with the heat dissipation material layer 13.

The fluorine-containing crystalline polymer may comprise PETFE or PVDF. In an embodiment, PETFE uses Q3-9030 or Tefzel™ from Dow Chemical. The heat conductive fillers may be oxide or nitride. The coupling agent is 0.5-3% of the heat conductive fillers by weight and the chemical formula is

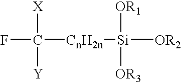

where R₁, R₂ and R₃ are alkyl group CₐH₂ₐ₊₁, a≧1;
X and Y are selected from: hydrogen(H), fluorine (F),
chorine (Cl), alkyl (CₐH₂ₐ₊₁) group; and
n is a positive integer.

In order to clearly understand the influence of the coupling agent, a comparison test is performed with the same process except the time of the mixing in the ball grinding jar is changed to 20 minutes and the coupling agent is not introduced. The results of voltage-endurance and bending tests of the experiments of various percentages of coupling agents and the comparison test are shown in Table 1.

The voltage-endurance test is performed as a pressure cook test (PCT), in which the specimens are exposed to saturated vapor pressure of 2 atm and 121° C. for 24 hours. If the specimens are not sufficiently solid, the intervening steam will decrease the voltage endurance performance. For the bending test, the second metal foil is removed from a specimen having a width of 1 cm, i.e., the specimen has only one copper foil, then the specimen is bent to a circle, and the minimum diameter of the specimen without break is recorded.

TABLE 1

| | Composition | | | | | |
|---|---|---|---|---|---|---|
| | | Heat | | Voltage endurance test | | |
| | | conductive | Coupling | | PCT/ | Bending |
| | Polymer | filler | agent | initial | 24 hours | test |
| No. | (PETFE) | (Al₂O₃) | (wt %) | (KV/0.2 mm) | (KV/0.2 mm) | (mm) |
| Comp. | 24 | 76 | — | 6.4 | 0.01 | >10 |
| Ex. 1 | | | 0.75 | 6.3 | 2.7 | 8 |
| Ex. 2 | | | 1.0 | 5.8 | 3.9 | 5 |
| Ex. 3 | | | 1.25 | 5.8 | 3.0 | 3 |
| Ex. 4 | | | 1.5 | 5.5 | 3.2 | 2 |
| Ex. 5 | | | 1.75 | 5.0 | 2.1 | 2 |

As shown in Table 1, the voltage endurance of the comparison test (Comp.) without coupling agent is significantly decreased after pressure cooking in comparison with initial state, and the experiment tests 1-5 (Ex. 1-Ex. 5) with coupling agents still can withstand high voltage (>2 KV) after pressure cooking, and the weight ratio of the coupling agent and the heat conductive fillers is preferably between 0.75-1.5%, which provides better voltage endurance performance. Moreover, all experiment tests show that the specimen break diameter is smaller than 10 mm in bending tests, and the performance can be significantly improved by the increase of the percentage of coupling agents, as bending test performance is much better in tests with coupling agent than in tests with no coupling agent (where the specimen break diameter is greater than 10 mm). In other words, more coupling agent can make the specimen more pliable, such that better bending performance can be obtained.

The percentages of the fluorine-containing crystalline polymer and the heat conductive fillers can be adjusted, while still keeping the same performance. Preferably, weight percentage of the fluorine-containing crystalline polymer is 15-40%, and the weight percentage of the heat conductive fillers is 60-85%. The coupling agent is 0.5-3% of the heat conductive fillers by weight.

In addition, the heat conductive polymer can be selected from the group consisting of polytetrafluoroethylene (PTFE), tetrafluoroethylene-hexafluoro-propylene copolymer (FEP), ethylene-tetrafluoroethylene copolymer (ETFE), perfluoroalkoxy modified tetrafluoroethylenes (PFA), poly(chlorotri-fluorotetrafluoroethylene) (PCTE), vinylidene fluoride-tetrafluoroethylene copolymer (VF-2-TFE), poly(vinylidene fluoride), tetrafluoroethylene-perfluorodioxole copolymers, vinylidene fluoride-hexafluoropropylene copolymer, vinylidene fluoride-hexafluoropropylene-tetrafluoroethylene terpolymer, and tetrafluoroethylene-perfluoromethylvinylether plus cure site monomer terpolymer.

Heat conductive filler can be oxide or nitride; the oxide can be selected from the group consisting of zirconium nitride (ZrN), boron nitride (BN), aluminum nitride (AlN), silicon nitride (SiN). The oxide can be selected from the group consisting of aluminum oxide (Al₂O₃), magnesium oxide (MgO), silicon oxide (SiO₂), zinc oxide (ZnO), titanium dioxide (TiO₂).

The heat conductive coefficient of the heat dissipation material is greater than 1.0 W/m-K or 1.5 W/m-K, which reflects much higher heat dissipation efficiency in comparison with traditional fiberglass such as FR4.

The heat dissipation material of the present invention has high heat conductive efficiency, high voltage endurance, and the heat dissipation substrate made of heat dissipation material with superior bending performance. Consequently, they can be applied to printed circuit boards, illuminated LED modules for heat dissipation, or folded products such as notebook computers or cellular phones for heat dissipation.

The above-described embodiments of the present invention are intended to be illustrative only. Numerous alternative embodiments may be devised by those skilled in the art without departing from the scope of the following claims.

What is claimed is:

1. A heat dissipation material with a heat conductive coefficient greater than 1.0 W/m-K, comprising:
fluorine-containing crystalline polymer having a melting point higher than 150° C;
heat conductive fillers dispersed in the fluorine-containing crystalline polymer; and
coupling agent of a chemical formula: 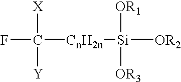
where R₁, R₂ and R₃ are alkyl group CₐH₂ₐ₊₁, a≧1;
X and Y are selected from hydrogen, fluorine, chorine, and
alkyl group; and
n is a positive integer.

2. The heat dissipation material of claim 1, wherein the fluorine-containing crystalline polymer has a weight percentage of 15-40%, the heat conductive fillers have a weight percentage of 60-85%, and the coupling agent is 0.5-3% of the heat conductive fillers by weight.

3. The heat dissipation material of claim 1, wherein the fluorine-containing crystalline polymer is selected from the group consisting of polyvinylidene fluoride (PVDF) and polyethylenetetrafluoroethylene (PETE).

4. The heat dissipation material of claim 1, wherein the fluorine-containing crystalline polymer is selected from the group consisting of polytetrafluoroethylene (PTFE), tetrafluoroethylene-hexafluro-propylene copolymer (FEP), ethylene-tetrafluoroethylene copolymer (ETFE), perfluoroalkoxy modified tetrafluoroethylenes (PFA), poly(chlorotri-fluorotetrafluoroethylene) (PCTE), vinylidene fluoride-tetrafluoroethylene copolymer (VF-2-TE), poly(vinylidene fluoride), tetrafluoroethylene-perfluorodioxole copolymers, vinylidene fluoride-hexafluoropropylene copolymer, vinylidene fluoride-hexafluoropropylene-tetrafluoroethylene terpolymer, and tetrafluoroethylene-perfluoromethylvinylether plus cure site monomer terpolymer.

5. The heat dissipation material of claim 1, wherein the coupling agent is 0.75-1.5% of the heat conductive fillers by weight.

6. The heat dissipation material of claim 1, wherein the heat conductive fillers are selected from oxide or nitride.

7. The heat dissipation material of claim 6, wherein the oxide is selected from the group consisting of aluminum oxide, magnesium oxide, silicon oxide, zinc oxide and titanium dioxide.

8. The heat dissipation material of claim 6, wherein the nitride is selected from the group consisting of zirconium nitride, boron nitride, aluminum nitride and silicon nitride.

9. A heat dissipation substrate, comprising:
a first metal foil;
a second metal foil;
a heat dissipation material layer laminated between the first metal foil and the second metal foil by physical contact, with the heat dissipation material layer having a heat conductive coefficient greater than 1 W/m-K and a thickness less than 0.5 mm, comprising:
fluorine-containing crystalline polymer having a melting point higher than 150° C;
heat conductive fillers dispersed in the fluorine-containing crystalline polymer; and
coupling agent of a chemical formula: 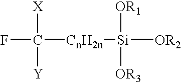
where R₁, R₂ and R₃ are alkyl group CₐH₂ₐ₊₁, a≧1;
X and Y are selected from hydrogen, fluorine, chlorine,
and alkyl group; and
n is a positive integer.

10. The heat dissipation substrate of claim 9, wherein the fluorine-containing crystalline polymer has a weight percentage of 15-40%, the heat conductive fillers have a weight percentage of 60-85%, and the coupling agent is 0.5-3% of the heat conductive fillers by weight.

11. The heat dissipation substrate of claim 9, wherein the fluorine-containing crystalline polymer is selected from the group consisting of polyvinylidene fluoride (PVDF) and polyethylenetetrafluoroethylene (PETFE).

12. The heat dissipation substrate of claim 9, wherein the fluorine-containing crystalline polymer is selected from the group consisting of polytetrafluoroethylene (PTFE), tetrafluoroethylene-hexafluoro-propylene copolymer (FEP), ethylene-tetrafluoroethylene copolymer (ETFE), perfluoroalkoxy modified tetrafluoroethylenes (PFA), poly(chlorotri-fluorotetrafluoroethylene) (PCTE), vinylidene fluoride-tetrafluoroethylene copolymer (VF-2-TFE), poly(vinylidene fluoride), tetrafluoroethylene-perfluorodioxole copolymers, vinylidene fluoride-hexafluoropropylene copolymer, vinylidene fluoride-hexafluoropropylene-tetrafluoroethylene terpolymer, and tetrafluoroethylene-perfluoromethylvinylether plus cure site monomer terpolymer.

13. The heat dissipation substrate of claim 9, wherein the heat conductive fillers are selected from the group consisting of aluminum oxide, magnesium oxide, silicon oxide, zinc oxide, titanium dioxide, zirconium nitride, boron nitride, aluminum nitride and silicon nitride.

14. The heat dissipation substrate of claim 9, wherein the heat dissipation substrate is capable of being bent to a circle of 10 millimeters without breaking or cracking on the surface where the heat dissipation substrate is of a width of 1 centimeter and the second metal foil is removed, wherein the first metal foil has a thickness less than 0.2 mm.

15. The heat dissipation substrate of claim 9, wherein the heat dissipation substrate can withstand a voltage larger than 2 KV/0.2 mm after being subjected to saturated vapor at 2 atm and 121° C. for 24 hours.

16. The heat dissipation substrate of claim 9, wherein the first and second metal foils are copper foils.
